(19) United States
(12) Patent Application Publication
(10) Pub. No.: US 2006/0210748 A1
(43) Pub. Date: Sep. 21, 2006

(54) Method for reducing freeze-thaw voids in uncured adhesives

(76) Inventor: Derek Wyatt, Long Beach, CA (US)

Correspondence Address: NATIONAL STARCH AND CHEMICAL COMPANY, P.O. BOX 6500, BRIDGEWATER, NJ, 08807-3300, US

(21) Appl. No.: 11/402,170

(22) Filed: May 30, 2006

Related U.S. Application Data
(62) Division of application No. 10/816,093, filed on Apr. 1, 2004.

(51) Int. Cl. B32B 27/08

(52) U.S. Cl. 428/35.7; 428/141

(57) ABSTRACT

A method for reducing the level of freeze-thaw voids in an uncured adhesive subjected to freezing and thawing comprises storing the adhesive in a container in which the walls of the container are a thermoplastic material and have been thinned and roughened.

### FIELD OF THE INVENTION

This invention relates to a method for reducing the number of freeze thaw voids in uncured adhesives and to containers for storing uncured adhesives at temperatures near or below the freezing point of the adhesive.

### BACKGROUND OF THE INVENTION

When an uncured adhesive is stored at a temperature near or below its freezing point, and is then brought into ambient temperatures for thawing, air voids can form between the wall of the container and the adhesive. This occurs as the container warms faster than the adhesive, expands and pulls away from the adhesive, introducing a space between the adhesive and the container wall. This phenomenon is often referred to as delamination between the adhesive and container. Upon thawing, as the adhesive re-wets the walls of the container, air located between the container and adhesive may become entrapped. The amount of air entrapped is related to the number of freeze/thaw cycles to which the adhesive is subjected. Within the microelectronics industry, uncured adhesive is commonly shipped in syringes under temperature conditions below the freezing point of the adhesive. If air voids form within the uncured adhesive, the voids can cause incomplete dispense patterns and tailing when the adhesive is dispensed. This type of void is commonly referred to as a freeze-thaw void (FTV). Another problem that can occur during the freeze/thaw cycle is cracking within the bulk of the adhesive. When this happens, air can be introduced into the cracks. Upon thaw, the air accumulates into micro bubbles that cause the same issues as FTVs, however in this case the air is scattered throughout the bulk adhesive.

This invention comprises a solution to the above problem by providing a container that mechanically or chemically increases the bonding strength of the frozen, uncured adhesive to the walls of the container, and/or that is sufficiently compliant to allow the adhesive to remain in contact with the container walls during freeze-thaw cycles.

### SUMMARY OF THE INVENTION

This invention is a method for reducing the level of freeze-thaw voids in an uncured adhesive subjected to freezing and thawing comprising storing the adhesive in a container in which the walls of the container are a thermoplastic material and (i) have a thickness of 0.0254 mm to 0.762 mm (1 to 30 mils) or (ii) have a thickness of 0.0254 to 1.524 mm (1 to 60 mils) and are roughened to have a mean roughness value of greater than 0.3 μm. In another embodiment, this invention is a container suitable for containing an uncured adhesive at a temperature near or below the freezing point of the adhesive in which the walls of the container are a thermoplastic material and (i) have a thickness of 0.0254 mm to 0.762 (1 to 30 mils) or (ii) have a thickness of 0.0254 to 1.524 mm (1 to 60 mils) and are roughened to have a mean roughness value of greater than 0.3 μm. In a preferred embodiment, the container is a syringe.

### BRIEF DESCRIPTION OF THE DRAWINGS

FIG. 1 shows the effects of roughening on the FTV performance of adhesive A while using a syringe with a wall thickness of 0.762 mm.

FIG. 2 shows the effects of wall thickness on the FTV performance of adhesive A while maintaining a roughness (Ra) of 2.9 microns.

FIG. 3 shows the effects of roughening on the FTV performance of adhesive B while using a syringe with a wall thickness of 1.524 mm.

FIG. 4 shows the effects of wall thickness on the FTV performance of adhesive B while maintaining a roughness (Ra) of 2.9 microns.

### DETAILED DESCRIPTION OF THE INVENTION

The thinness of the walls of the container makes the container more compliant or flexible. As thawing of the adhesive occurs, the walls of the container expand faster than the adhesive. The added flexibility allows the container to move with the adhesive and inhibit the creation of space between the adhesive and the walls. Similarly, a very compliant syringe material will be more likely to conform to the adhesive as it shrinks and expands than a less compliant syringe material, thus reducing the likelihood of delamination and the formation of FTVs. The roughness of the inside walls of the container increases mechanical bonding of the adhesive to the walls. The mean roughness value (R_{a) is the surface texture of the walls of the container as measured with a surface profilometer. It is the arithmetic average of the absolute values of the roughness profile ordinates; that is, the average height of the contours that creates the roughness. In order for adhesion to be increased sufficiently to reduce the formation of air voids, the R}ₐ value should be greater than 0.3 μm for containers prepared of thermoplastic materials.

Roughening or adding contours to the inside container walls can be accomplished by any method effective for obtaining the necessary Rₐ value, for example, by adding contours to the interior walls of the container during fabrication, mechanical abrasion, plasma etching, chemical etching or corona discharge, either during or after construction of the container. The syringe mold can be made rougher, resulting in a rougher syringe surface, by reducing the level of polish used on the mold surface or by adding contours or bumps to the syringe wall surfaces. Mechanical abrasion can be accomplished, for example, by rubbing the inside of the syringe with sand paper, sandblasting it, or scraping or scoring it with a tool, as well as any other method of abrasion that would result in an increased surface roughness.

Plasma etching could be performed on the container using a variety of gasses, including SF₆, O₂, Ar, CF₄, CHF₃, and O₃. The container could be treated via corona discharge using conditions known in the art, at an intensity and duration dictated by the desired level of roughening.

Alternatively, the roughening can be accomplished by chemically etching the surface using a chromic acid solution, in which the container would be immersed in the solution for 60-90 minutes at ambient temperature or 1-2 minutes at 65-70° C. The chromic acid solution should be composed of sodium dichromate (15 parts/weight), distilled water (24 parts/weight), and concentrated sulfuric acid (300 parts/weight).

In another method, adhesion can be enhanced chemically by coating the inside of the container with a primer for plastic material. Suitable primers for polypropylene-based containers include chlorinated polypropylene primers such as SUPERCHLON S-3199 available from Nippon Unipac Holding Group, non-chlorinated primers such as Eastman AP 440-1 available from Eastman Chemical Company, and acrylic enamels such as Abrex 44-series acrylic enamels available from Abrex Paint and Chemical Ltd. Suitable primers for polyethylene-based containers include primers such as Eastman chlorinated polyolefin CP 153 available from Eastman Chemical Company and acrylic enamels such as Abrex 44-series acrylic enamels available from Abrex Paint and Chemical Ltd. Such primers may be applied by spraying or brushing it on, by spin coating, or by dipping.

Preferred thermoplastic materials are injection moldable and have a flexural modulus of less than or equal to 1240 MPa (180,000 psi). Suitable materials are selected from the group consisting of polypropylene, polyethylene, ethylene-ethyl acrylate copolymer, ethylene-vinyl acetate copolymer, high density polyethylene, low density polyethylene, ethylene-octene copyolymer, ethylene-hexene copolymer, ethylene-butene copolymer, polypropylene homopolymer, polypropylene copolymer, and polypropylene random copolymer. These materials are commercially available and can be obtained, for example, from The Dow Chemical Company, E.I. du Pont de Nemours and Company, ExxonMobil, or Union Carbide Corporation.

Embodiments of the invention can vary as the dispensing needs dictate. In one embodiment the preferred thermoplastic container is a thermoplastic syringe. In another embodiment the preferred thermoplastic container is a compliant syringe used within a more rigid sleeve.

Testing was conducted by filling 10 cc sized polypropylene syringes with adhesive. Two exemplary adhesive chemistry types were tested. Adhesive A was ABLEFILL UF8822 underfill encapsulant, which is based on moisture-resistant cyanate ester chemistry and has a freezing point of −17° C. Adhesive B was ABLEBOND 84-3MVBTI adhesive, which is based on epoxy chemistry and has a freezing point of −38° C. Both adhesives are commercially available from Ablestik Laboratories. The syringes were placed in a variety of freezers to achieve a range of storage temperatures below the freezing point of the adhesive. Syringe temperature was measured using a thermocouple attached to the side of the syringe in the middle of the length of the barrel. The material was allowed to remain frozen for a minimum of 2 hours and was then removed from the freezer and allowed to set at room temperature (20-25° C.) until the temperature of the syringe was at the freezing point of the adhesive. The syringe was then visually examined for cracks, freeze/thaw voids, or delamination. After the adhesive reached room temperature the syringe was visually examined for freeze-thaw voids. Any level of cracking, delamination, or freeze-thaw voids was considered a failure for that specimen. Ten specimens were tested for each data point and the percentage of specimen failure was recorded.

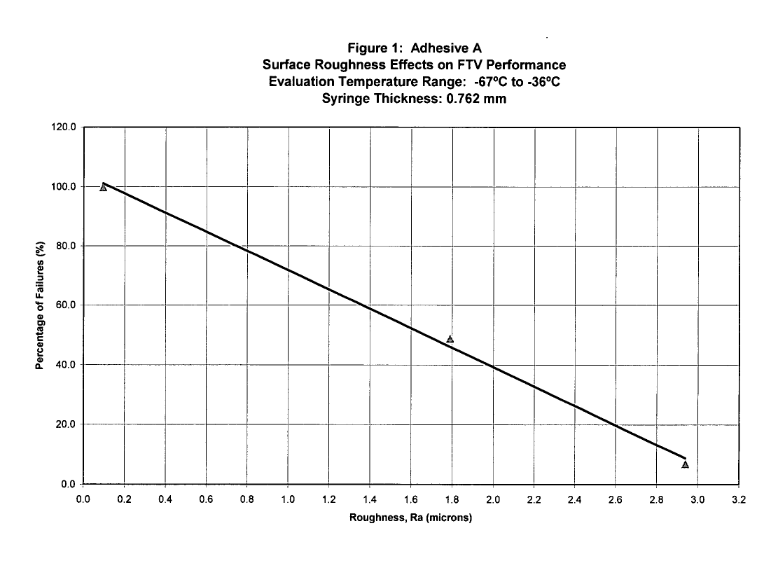

Results are presented in FIGS. 1-4. FIG. 1 shows the effects of roughening on the FTV performance of adhesive A while using a syringe with a wall thickness of 0.762 mm. In the example below, increasing the roughness (Ra) from 0.1 microns to 2.9 microns decreased the number of failed syringes from 100% to less than 10% for the temperature range between −67° C. to −36° C.

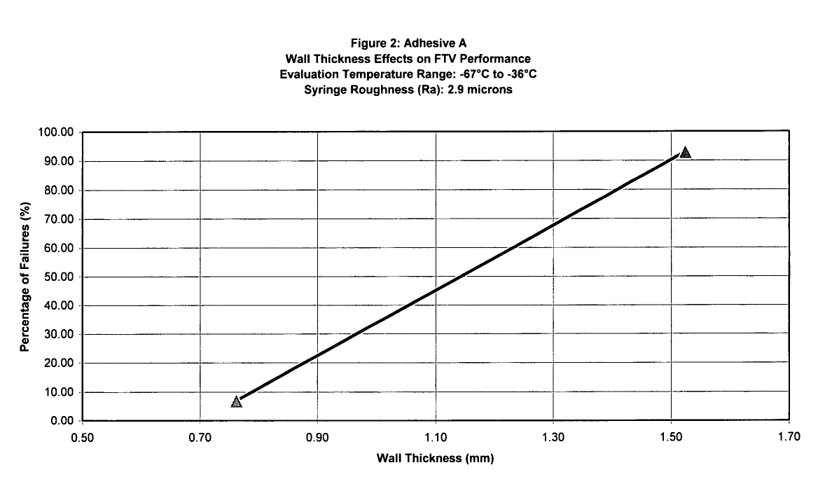

FIG. 2 shows the effects of wall thickness on the FTV performance of adhesive A while maintaining a roughness (Ra) of 2.9 microns. In the example below, as the wall thickness was decreased from 1.524 mm to 0.762 mm, the percentage of failed syringes dropped from approximately 90% to less than 10% for the temperature range between −67° C. to −36° C.

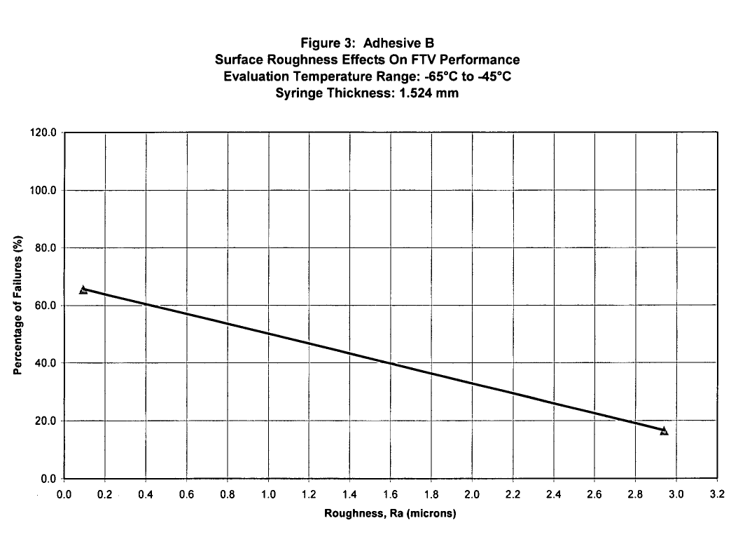

FIG. 3 shows the effects of roughening on the FTV performance of adhesive B while using a syringe with a wall thickness of 1.524 mm. As the roughness was increased, the percentage of failed syringes decreases. In the example below, increasing the roughness (Ra) from 0.1 microns to 2.9 microns decreased the number of failed syringes from approximately 65% to less than 20% for the temperature range between −65° C. to −45° C.

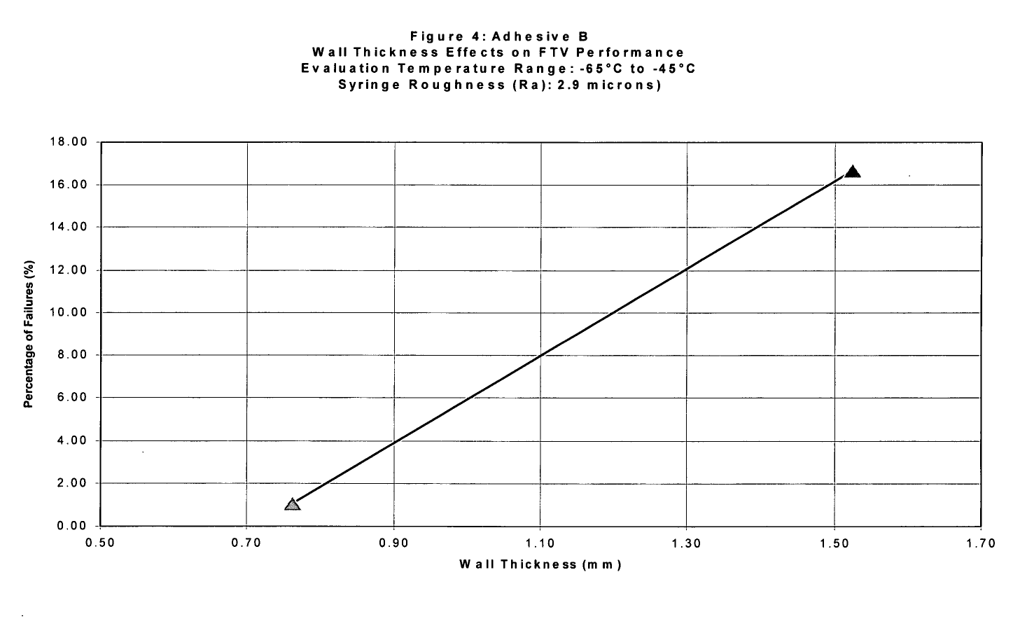

FIG. 4 shows the effects of wall thickness on the FTV performance of adhesive B while maintaining a roughness (Ra) of 2.9 microns. In the example below, as the wall thickness was decreased from 1.524 mm to 0.762 mm, the percentage of failed syringes dropped from approximately 16% to less than 2% for the temperature range between −65° C. to −45° C.

1-7. (canceled)

8. A container in which the walls of the container are a thermoplastic material and
(i) have a thickness of 0.0254 mm to 0.762 mm or
(ii) have a thickness of 0.0254 to 1.524 mm and are roughened to have a mean roughness value of greater than 0.3 μm.

9. The container according to claim 8 in which the container is a syringe or a syringe within a rigid sleeve.
